(19) United States
(12) Patent Application Publication
(10) Pub. No.: US 2024/0272948 A1
(43) Pub. Date: Aug. 15, 2024

(54) ADAPTIVE SCHEDULING FOR AUTONOMOUS VEHICLE SOFTWARE BUILDS

(71) Applicant: GM Cruise Holdings LLC, San Francisco, CA (US)

(72) Inventor: Mahaaveer Prabu Jayabalan, San Jose, CA (US)

(73) Assignee: GM Cruise Holdings LLC, San Francisco, CA (US)

(21) Appl. No.: 18/167,209

(22) Filed: Feb. 10, 2023

(51) Int. Cl. G06F 9/50; G06N 20/00

(52) U.S. Cl. CPC G06F 9/5027; G06N 20/00

(57) ABSTRACT

Systems and methods related to adaptively select a scheduling strategy for vehicle software related jobs and/or tasks in an infrastructure environment are provided. A computer-implemented system, including one or more processing units; and one or more non-transitory computer-readable media storing instructions, when executed by the one or more processing units, cause the one or more processing units to receive a plurality of requests, each requesting execution of a task associated with a software for a vehicle operation; select, for an individual task based on an attribute of the individual task, a scheduler from among a plurality of schedulers of different scheduler types; determine, by the selected scheduler, a schedule to execute the individual task on an infrastructure computing system including a plurality of resources, where the determining comprises scheduling a resource from the plurality of resources; and transmit an instruction to execute the individual task using the scheduled resource.

### BACKGROUND

### 1. Technical Field

The present disclosure generally relates to autonomous vehicles and, more specifically, to adaptive scheduling for autonomous vehicle software related jobs and/or tasks in an infrastructure environment.

### 2. Introduction

Autonomous vehicles, also known as self-driving cars, driverless vehicles, and robotic vehicles, may be vehicles that use multiple sensors to sense the environment and move without human input. Automation technology in the autonomous vehicles may enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating the vehicles in making driving decisions. The vehicles can be used to pick up passengers and drive the passengers to selected destinations. The vehicles can also be used to pick up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a block diagram illustrating an infrastructure framework for autonomous vehicle (AV) software builds and/or AV simulations, according to embodiments of the present disclosure;

FIG. 2 is a block diagram illustrating an exemplary distributed resource pool configuration for AV software builds and/or AV simulations, according to embodiments of the present disclosure;

FIG. 3 illustrates an exemplary adaptive scheduling scheme for scheduling AV software related tasks in an infrastructure environment, according to some embodiments of the present disclosure;

FIG. 4 illustrates an exemplary scheduling scheme of a plurality of scheduling schemes used by an adaptive scheduler for scheduling AV software related tasks in an infrastructure environment, according to some embodiments of the present disclosure;

FIG. 5 illustrates an exemplary scheduling scheme of a plurality of scheduling schemes used by an adaptive scheduler for scheduling AV software related tasks in an infrastructure environment, according to some embodiments of the present disclosure;

FIG. 6 illustrates an exemplary scheduling scheme of a plurality of scheduling schemes used by an adaptive scheduler for scheduling AV software related tasks in an infrastructure environment, according to some embodiments of the present disclosure;

FIG. 7 illustrates an exemplary task-to-scheduler mapping scheme for adaptive scheduling in an infrastructure environment, according to some embodiments of the present disclosure;

FIG. 8 illustrates an exemplary resource allocation scheme for adaptive scheduling in an infrastructure environment, according to some embodiments of the present disclosure;

FIG. 9 is a flow diagram illustrating an exemplary adaptive scheduling process for scheduling AV software related tasks in an infrastructure environment, according to some embodiments of the present disclosure;

FIG. 10 illustrates an example system environment that may be used to facilitate AV dispatch and operations, according to some aspects of the disclosed technology; and

FIG. 11 illustrates an example processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Autonomous vehicles (AVs) can provide many benefits. For instance, AVs may have the potential to transform urban living by offering opportunities for efficient, accessible and affordable transportation. An AV may be equipped with various sensors to sense an environment surrounding the AV and collect information (e.g., sensor data) to assist the AV in making driving decisions. To that end, the collected information or sensor data may be processed and analyzed to determine a perception of the AV's surroundings, extract information related to navigation, and predict future motions of the AV and/or other traveling agents in the AV's vicinity. The predictions may be used to plan a path for the AV (e.g., from a starting position to a destination). As part of planning, the AV may access map information and localize itself based on location information (e.g., from location sensors) and the map information. Subsequently, instructions can be sent to a controller of the AV to control the AV (e.g., for steering, accelerating, decelerating, braking, etc.) according to the planned path.

The operations of perception, prediction, planning, and control of an AV may be implemented using a combination of hardware and software components. For instance, an AV stack or AV compute process performing the perception, prediction, planning, and control may be implemented using one or more of software code and/or firmware code. However, in some embodiments, the software code and firmware code may be supplemented with hardware logic structures to implement the AV stack and/or AV compute process. The AV stack or AV compute process (the software and/or firmware code) may be executed on processor(s) (e.g., general-purpose processors, central processing units (CPUs), graphical processing units (GPUs), digital signal processors (DSPs), application specific integrated circuits (ASICs), etc.) and/or any other hardware processing components on the AV. Additionally, the AV stack or AV compute process may communicate with various hardware components (e.g., onboard sensors and control systems of the AV) and/or with an AV infrastructure over a network.

Training and testing AVs in the physical world can be challenging. For instance, to provide good testing coverage, an AV may be trained and tested to respond to various driving scenarios (e.g., millions of physical road test scenarios) before it can be deployed in an unattended real-life roadway system. As such, it may be costly and time-consuming to train and test AVs on physical roads. Furthermore, there may be test cases that are difficult to create or too dangerous to cover in the physical world. Accordingly, it may be desirable to train and validate AVs in a simulation environment, covering at least a majority of the test scenarios. In this way, the number of physical road tests can be reduced while still providing good test coverage. Further, autonomous driving algorithms can be developed, fine-tuned, and tested with a shorter turn-around time on a simulation platform than it would have been with physical road tests

A simulator may simulate (or mimic) real-world conditions (e.g., roads, lanes, buildings, obstacles, other traffic participants, trees, lighting conditions, weather conditions, etc.) so that the AV stack and/or AV compute process of an AV may be tested in a virtual environment that is close to a real physical world. Testing AVs in a simulator can be more efficient and allow for creation of specific traffic scenarios. To that end, the AV compute process implementing the perception, prediction, planning, and control algorithms can be developed, validated, and fine-tuned in a simulation environment. More specifically, the AV compute process may be executed in an AV simulator (simulating various traffic scenarios), and the AV simulator may compute metrics related to AV driving decisions, AV response time, etc. to determine the performance of an AV to be deployed with the AV compute process.

While AV simulation can allow for validation of AV behaviors with newly developed autonomous driving algorithms across a large number of driving scenarios before deploying those algorithms in a real-life roadway system, providing an infrastructure that can support a large number of AV simulation runs on a daily basis can be challenging. Further, an infrastructure platform may be used not only to provision for AV simulation runs, but also for various stages of AV software development and release integration. For instance, after an algorithm is validated through simulation, the validated algorithm may be integrated and compiled into an AV software build (e.g., a certain version of software or firmware). In software development, a build is a process of compiling (or converting) software program source codes into an image (e.g., a binary image) that can be executed by a computer-implemented system. The integrated software build may be further tested. For instance, a set of test cases covering various driving scenarios may be defined and the integrated AV software build may be tested against these test cases. After successfully testing the integrated AV software build, the integrated AV software build may be compiled into an AV software release and the AV software release may be further tested (e.g., against the same set of test cases or a different or more extensive set of test cases) before the AV software release is deployed in AVs for real-road testing and real-road driving. Further, an infrastructure platform may be used to train machine learning (ML) models that are used to perform perception, prediction, path planning, and/or control for determining a driving decision to navigate an AV. As such, the number of AV simulations, AV software builds, and ML model training that run on the infrastructure platform may reach hundreds of thousands per day. Furthermore, the number of AV simulations, AV software builds, and ML model training sessions may continue to grow as more driving scenarios are identified and/or generated and/or more advanced algorithms are being developed, tested, released, and deployed.

In some examples, an infrastructure platform may be built on top of a cloud platform that provides various resources, such as compute resources (e.g., CPU cores and GPU cores), memory resources, storage resources, and/or network resources, for running AV software related tasks (e.g., AV simulations, AV software builds, and ML model trainings). In an example, the cloud platform may include a shared pool of configurable resources and may present its resources to a cloud user (e.g., the infrastructure platform) in the form of workers or virtual machines (VMs). To that end, a worker may be configured with a specific computational capacity (e.g., 12 CPU cores and 12 GPU core, 12 CPU cores with no GPU core, etc.), a specific storage capacity (e.g., 128 gigabytes (GB) of disk storage, 256 GB of disk storage, etc.), a specific memory capacity (e.g., 16 GB of random-access memory (RAM), 32 GB of RAM, etc.), and/or a specific network capacity (e.g., an uplink bandwidth or throughput and/or a downlink bandwidth or throughput). The cloud platform may be provided by a third-party provider, and each unit of resources or each worker may have an associated cost. Accordingly, it may be desirable to schedule resources in a way that can optimize resource utilization and minimize cost.

Different AV software related tasks may have different execution properties, constraints, and/or resource requirements. As an example, an AV simulation may take a few minutes to a few hours to complete its execution while an AV software build may only take a few seconds to complete its execution. As another example, an AV software release build may be tested against a large set of test cases (e.g., hundreds to thousands of test cases), and thus may take a couple of days to complete. On the other hand, an AV software developer build may be tested against a small set of test cases (e.g., a few test cases to tens of test cases), and thus may take an hour to a few hours to complete. As a further example, an AV software release build may have to be completed by an expected or planned release date while an AV software developer build may not have an urgent deadline, and thus can wait. Accordingly, it may be undesirable for an infrastructure platform to use a single scheduling strategy to schedule different types of AV software related tasks.

The present disclosure provides techniques for performing adaptive scheduling in an infrastructure environment to facilitate algorithm development, ML model training, simulation, and/or continuous integration related to AV software. The adaptive scheduling may include pairing of various scheduling strategies to vehicle software related tasks at run-time so that a most suitable scheduling strategy may be used to schedule a particular task. The pairing may be based on attributes of the respective tasks. A task attribute may refer to a characteristic or parameter that defines key information or properties related to a respective task.

In an aspect of the present disclosure, a computer-implemented system may include one or more processing units and one or more non-transitory computer-readable media storing instructions, when executed by the one or more processing units, cause the one or more processing units to implement an adaptive scheduler for scheduling execution of jobs and/or tasks related to software for operating (or driving) a vehicle. Some examples of operations or calculations for operating a vehicle may include, but are not limited to, performing perception (e.g., to determine a perception of a vehicle's surroundings), prediction (e.g., to predict a future motion of the vehicle or a traffic participant in the vehicle's surroundings), planning (e.g., to determine a driving path for the vehicle), and/or control (e.g., to control a maneuver of the vehicle). The adaptive scheduler may include a scheduling manager and a plurality of schedulers of different scheduler types. For instance, each of the plurality of schedulers may utilize a different scheduling technique or strategy to schedule tasks for execution. A scheduling strategy may refer to how executions of tasks are ordered and/or how resources are assigned for the task executions. In an example, the scheduling manager may receive a plurality of requests. Each of the requests may request execution of a job including one or more tasks associated with software for operating (or driving) a vehicle.

As discussed above, different tasks may have different execution properties, constraints, and/or requirements, and thus may benefit from different scheduling techniques or strategies. To that end, the scheduling manager may map (or assign) each individual task of the requested tasks to one of the plurality of schedulers based on an attribute of the individual task. Stated differently, the scheduling manager may select a scheduler from among the plurality of different schedulers for each individual task based on an attribute of the individual task. A selected scheduler may determine a schedule for executing the respective task. As part of determining the schedule, the selected scheduler may schedule (or allocate) a resource from a plurality of resources (e.g., infrastructure resources, cloud resources) for the respective task. Subsequently, the adaptive scheduler (e.g., the scheduling manager or the selected scheduler) may send an instruction to instruct execution of the respective task on the scheduled resource according to the determined schedule. In an example, the plurality of resources may include a plurality of workers (e.g., cloud-based worker(s) or VM(s)), and the instruction may be sent to a resource manager that manages the workers or directly to the scheduled worker(s).

In some aspects, the attribute of an individual task may be associated with one of a simulation of a vehicle operation, a vehicle software build, or training of an ML model for at least one of a perception, prediction, planning, or control for a driving decision. In some aspects, the adaptive scheduler may include a first scheduler, a second scheduler, and a third scheduler, where each of the first, second, and third scheduler may implement a different scheduling strategy. For instance, the first scheduler may implement a first-in-first-out (FIFO)-based scheduling strategy that schedules tasks in the same order as respective requests are received. The second scheduler may implement a completion deadline-based scheduling strategy that prioritizes a task with an earlier deadline over another task with a later deadline and guarantees tasks are completed by the respective deadlines. The third scheduler may implement a gang scheduling strategy that schedules components (or sub-tasks) of the individual task for concurrent execution (e.g., with each component to be executed on a different one of multiple resources based on the multiple resources being available at the same time). As an example, if the scheduling manager determines that the attribute of the individual task is associated with the vehicle software build, the scheduling manager may select the first scheduler (the FIFO-based scheduler). Alternatively, if the scheduling manager determines that the attribute of the individual task is associated with the simulation of the vehicle operation, the scheduling manager may select the second scheduler (the completion deadline-based scheduler). Yet alternatively, if the scheduling manager determines that the attribute of the individual task is associated with the training of the ML model, the scheduling manager may select the third scheduler (the gang scheduler).

As discussed above, the plurality of resources may include a plurality of workers (e.g., cloud-based worker(s) or VM(s)). Each worker may be associated with one of a plurality of worker classes. Each worker class may include at least one of a compute resource (e.g., one or more CPUs and/or one or more GPUs), a memory resource, or a network resource. Accordingly, in some instances, as part of determining a schedule for an individual task, a selected scheduler for the individual task may assign one or more workers to execute the individual task.

In some aspects, each of the plurality of schedulers may be configured to schedule resources from a different subset of the plurality of resources. That is, each scheduler may schedule a resource from a respective subset of the plurality of resources for execution of a task. In some aspects, a mapping between the schedulers and the resources can be flexible, for example, based on availability of the subsets of resources. As an example, a first subset of the plurality of resources may be configured for a selected scheduler and a second subset of the plurality of resources may be configured for a different scheduler. The selected scheduler may first select an available resource from the first subset of resources (configured for the selected scheduler) for a task. If, however, there is no available resource in the first subset of resources, the selected scheduler may select an available resource from the second subset for the task. Additionally or alternatively, the mapping can vary depending on a variety of other factors, for example, including but not limited to, a time of the day (week or month), a cost of the resources, and/or a workload (e.g., a number job or task requests received and/or being executed at a certain time) at the time when a request for a task is receive.

In some aspects, the scheduling manager may receive a resource availability report. The resource availability report may include information indicating which of the plurality of resources are available (e.g., at a particular time), and the scheduling of the resource for each individual task may be based on the received resource availability report.

The systems, schemes, and mechanisms described herein can advantageously improve resource utilization, reduce cost, and/or improve task execution efficiencies by adaptively selecting a most suitable scheduling strategy to schedule a certain AV software related job or task based on associated attribute(s). While the present disclosure may discuss scheduling in the context of task scheduling in some embodiments, similar scheduling mechanisms may be applied to job scheduling. Further, the term “software build” may generally refer to an AV compute process (e.g., for perception, prediction, planning, and/or control operations) that can be executed on any suitable processors and/or hardware accelerators at a vehicle in operation. In some examples, a software build can also be referred to as a firmware build.

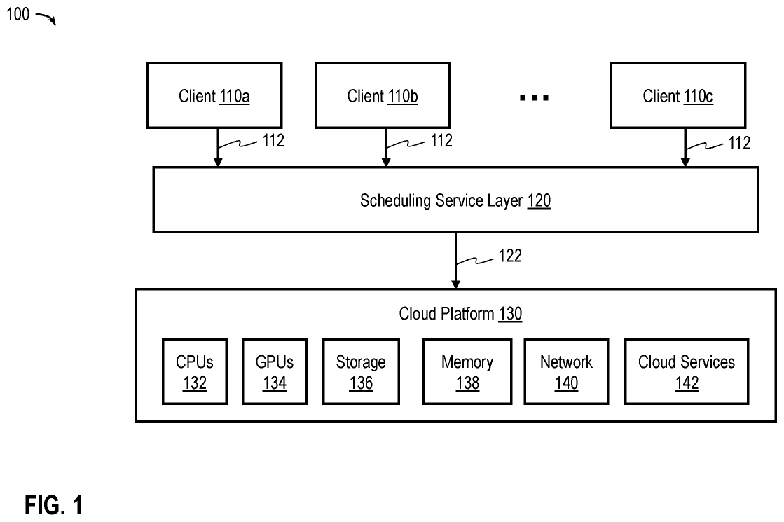

FIG. 1 is a block diagram illustrating an infrastructure framework 100 for AV software build(s) and/or AV simulation(s), according to some embodiments of the present disclosure. The infrastructure framework 100 may include a plurality of clients 110 (shown as 110a, 110b, . . . , 110c), a scheduling service layer 120, and a cloud platform 130. The cloud platform 130 may include a shared pool of configurable resources including CPU cores 132, GPU cores 134, storage resources 136 (e.g., disk space), memory 138 (e.g., RAMs), and/or network resources 140 (e.g., an uplink bandwidth, a downlink bandwidth, an uplink throughput, and/or a downlink throughput). The cloud platform 130 may also provide various cloud services 142 (e.g., databases hosting services, monitoring services, reporting services, query services, and/or container registry services, etc.) to assist scheduling and/or resource management. In some aspects, a provider of the cloud platform 130 may host the various resources and/or services at network data centers that are distributed in various geographical locations (e.g., at a west region of United States, an east region of United States, etc.). At a high level, the plurality of clients 110 (or client applications) may request the scheduling service layer 120 to execute certain AV simulation and/or software build jobs, and in response, the scheduling service layer 120 may schedule resources on the cloud platform 130 for execution of the requested jobs. Stated differently, the scheduling service layer 120 may operate as an abstraction layer to hide the underlying cloud platform 130 from the clients 110 so that the cloud platform 130 may be transparent to the clients 110.

The plurality of clients 110 may include AV simulation developers, AV software engineers, AV release and/or quality assurance (10) engineers, etc. The clients 110 may submit job requests 112 to the scheduling service layer 120, for example, via scheduling service application interface (API) calls. Each job may include a collection of one or more tasks associated with an AV simulation or an AV software build (e.g., including implementation of sensing algorithms, ML models to identify objects in a driving scenario, ML models to facilitate autonomous driving, etc.). For instance, an AV simulation developer may submit a job for an AV simulation, an AV software engineer may submit a job for an AV software build under development or integration, and an AV release and/or 10 engineer may submit a job for an AV software build in preparation for a release. In some aspects, the job request 112 may include a task specification specifying information (e.g., file information for AV driving scenario data or models, file information for processed AV artifacts for executing each task and/or an associated job completion deadline).

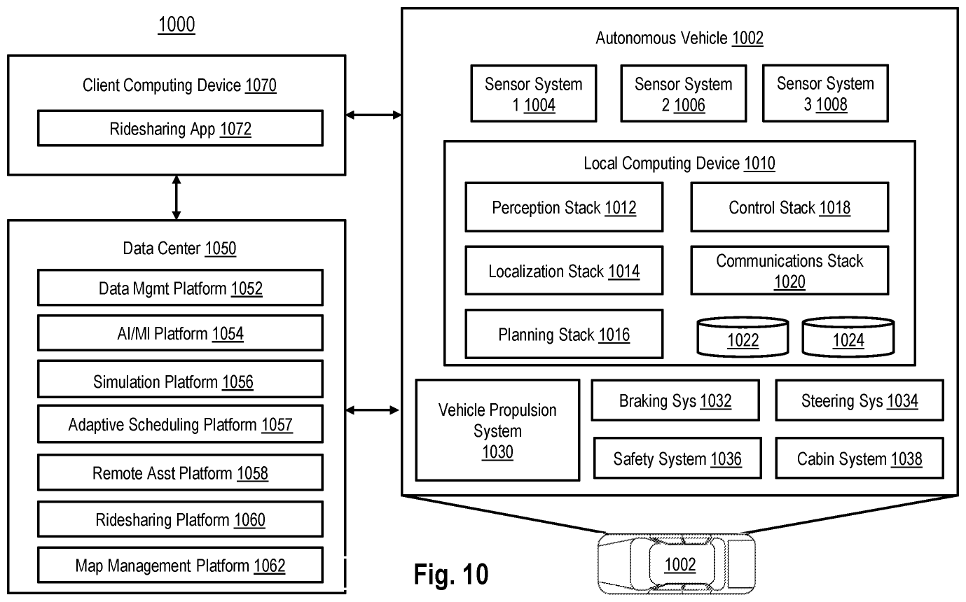

An AV simulation job may include various tasks related to execution of various AV simulations and/or analysis of the simulation outputs. An AV software build job may include compilation of various AV software and/or firmware builds, associated testing, and/or generation of software and/or firmware release packages (e.g., to be deployed in AVs similar to the AV 1002 shown in FIG. 10). As an example, a task may run a simulation that performs object identification in a certain driving scenario using an ML model. As another example, a task may run a simulation that simulates a certain sensor system and performs a certain sensing algorithm using the sensor system. As yet another example, a task may run an AV code (e.g., firmware or software) implemented based on a certain AV simulation. As yet another example, a task may compile a certain AV software or firmware build and run the compiled code over certain driving test scenarios. In general, a task may be associated with any stages within an AV code release life cycle (from simulation to code release). In some aspects, tasks within a job can be dependent on one another. As an example, an AV simulation job may include a first task to execute a simulation that simulates a certain sensor algorithm and/or system and generates sensor data using the sensor algorithm and/or system, and a second task to execute a simulation that performs object identification from sensor data generated from the first task. As another example, an AV code release job may include a first task to compile source codes of a certain software or firmware and a plurality of tasks to test the software or firmware under various driving scenarios. In general, a job may include a list of one or more tasks to execute an AV simulation (e.g., executing software associated perception, prediction, planning, and/or control for determining driving decision(s)) or to build certain AV software codes related to AV perception, prediction, planning, and/or control (e.g., for a release).

The cloud platform 130 may present its resources (e.g., the CPU cores 132, GPU cores 134, the storage resources 136, and/or memory 138) to the scheduling service layer 120 in the form of workers or worker instances. As an example, a worker may include 12 CPU cores 132, 4 GPU cores 134, 350 GB of storage resources 136 (e.g., disk space), and 64 GB of memory 138. As another example, a worker may include 4 CPU cores 132, 100 GB of storage resources 136, 32 GB of memory 138, and no GPU cores 134. In general, the cloud platform 130 may provision for any suitable number of workers with any suitable configuration or combination of resources.

Upon receiving a job request 112 from a client 110, the scheduling service layer 120 may schedule resources (e.g., workers) on the cloud platform 130 to execute task(s) requested by the job request 112. The scheduling service layer 120 may utilize any suitable scheduling schemes. Some example scheduling schemes may include, but are not limited to, a first-in-first-out (FIFO) scheduling scheme, a completion time-driven scheme, or a gang scheduling scheme. A FIFO scheduling scheme may schedule tasks in the order as they are submitted or requested. A completion time-driven scheme may schedule a task that has an earlier completion deadline over a task that has a later completion deadline and may guarantee that a task will be completed by the requested completion deadline. A gang scheduling scheme may schedule related tasks to run simultaneously on different resources (or processors). Subsequently, the scheduling service layer 120 may transmit a request 122 to the cloud platform 130 to schedule available worker(s) or launch (“spin up”) additional worker(s) to execute the tasks, for example, via remote procedure calls (RPCs). In some aspects, the scheduling service layer 120 may spin up a worker by executing a VM image on the cloud platform 130, and then download a separate binary task image (e.g., an executable image) to the worker for execution. In any case, the scheduling service layer 120 may be responsible for creating VM images (including scheduling within the VM), requesting the cloud platform 130 to launch or spin up certain workers, and assigning AV simulation and/or software build jobs to the workers. While not shown, in some aspects, the scheduling service layer 120 may also utilize or access map services to facilitate the execution of an AV simulation or software build job.

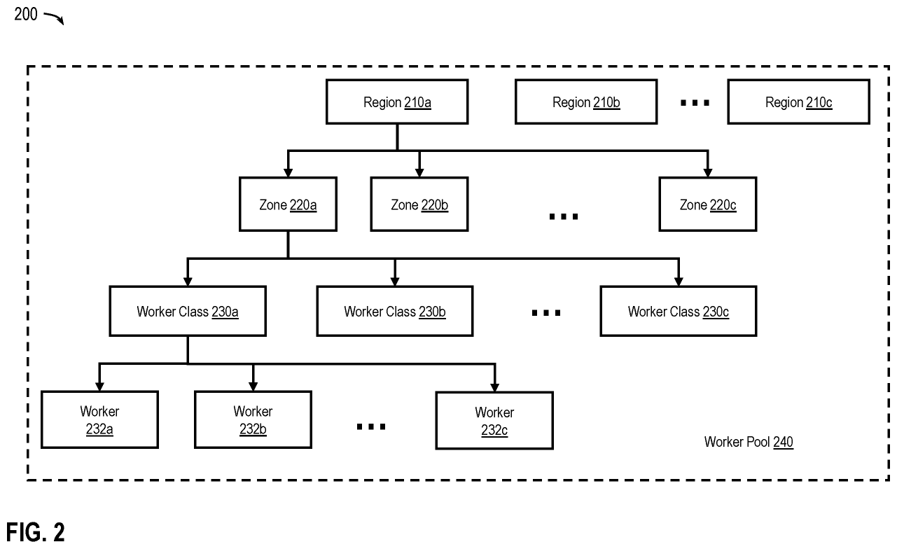

FIG. 2 is a block diagram illustrating an exemplary distributed worker pool configuration 200 for AV software builds and/or AV simulations, according to some embodiments of the present disclosure. In an example, the cloud platform 130 of FIG. 1 may include a worker pool similar to the worker pool 240 shown in the FIG. 2 to provide the CPU cores 132, GPU cores 134, the storage resources 136, the memory 138, the network resources 140, etc. for task execution. The worker pool 240 may be a shared pool of configurable resources distributed across multiple geographical locations. As shown, the worker pool 240 may include resources located at a plurality of regions 210 (shown as 210a, 210b, . . . , 210c). Some example regions 210 may include a region in Western United States, a region in Eastern United States, etc. Each region 210 may be partitioned into a plurality of zones or areas. In some instances, the different zones may correspond to different network data centers. For simplicity, FIG. 2 only illustrates zones 220 (shown as 220a, 220b, . . . , 220c) in the region 210a.

Each zone 220 may provision for various worker classes 230. A worker class 230 may be a template or a configuration of resource capacities. Different worker classes 230 may have different configurations for computational capacities, storage capacities, memory capacities, and/or network capacities. For instance, one worker class 230 may include a configuration for 12 CPU cores (e.g., the CPU cores 132), 4 GPU cores (e.g., the GPU cores 134), 350 GB of disk space (e.g., the storage resources 136), and 64 GB of memory (e.g., the memory 138), and another worker class 230 may include 4 CPU cores, 100 GB of storage resources, 32 GB of memory, and no GPU cores. includen general, a zone 220 may provision for any suitable number of worker classes 230 with a configuration for any suitable combination of resources. For simplicity, FIG. 2 only illustrates worker classes 230 (shown as 230a, 230b, . . . , 230c) in the zone 220a.

Each worker class 230 may be instantiated into one or more worker instances or workers 232 (e.g., 1, 2, 3, 4, 5, 10, 20, 40, 100 or more). A worker 232 instantiated from a worker class 230 may have the resource capacities (for compute, storage, memory, and/or networking) as specified by the worker class 230. For simplicity, FIG. 2 only illustrates workers 232 (shown as 232a, 232b, . . . , 232c) of the worker class 230a.

In some aspects, the worker pool 240 may provision for various types of workers, for example, including non-preemptible workers 232 (or “standard workers”) and preemptible workers 232 of any suitable worker classes 230. The non-preemptible workers 232 may include committed workers that are already purchased at a certain cost, for example, by an organization that utilizes the worker pool 240. The non-preemptible workers 232 can also include workers that can be launched (or “spin up”) on-demand at a small additional cost. Once a non-preemptible worker 232 is launched, the non-preemptible worker 232 can be used by the infrastructure platform for as long as the infrastructure platform desires. On the other hand, a preemptible worker 232 may be requested (or “spin up”) on-demand with a lower cost than the on-demand preemptible workers 232 but can be preempted (or taken away) at some time point of time. As such, while a preemptible worker 232 may have a lower cost, a task scheduled on a preemptible worker may have the risk of not running to completion and having to be rerun on another worker 232.

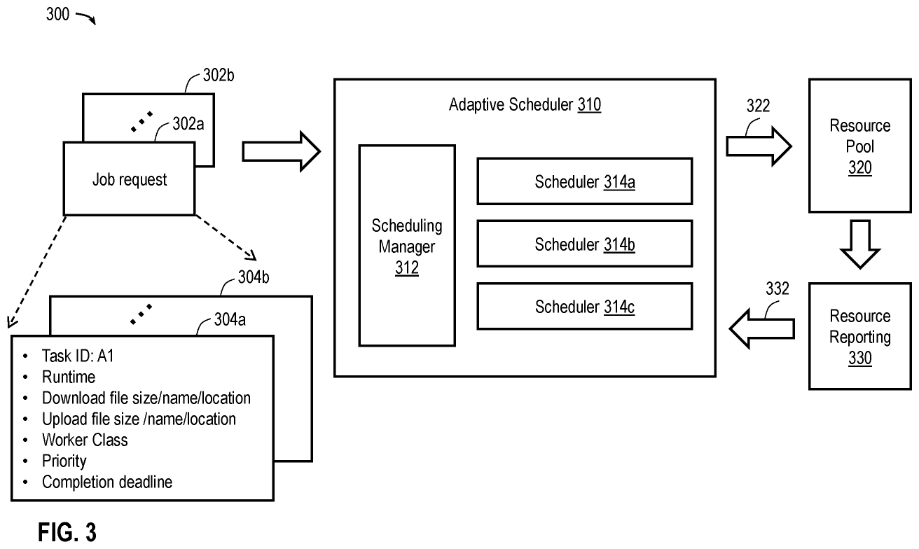

In general, a scheduler may have various resource options for assigning resources for task execution and it may be desirable for a scheduler (e.g., the scheduling service layer 120) to be able to schedule resources efficiently. FIGS. 3-9 illustrate various mechanisms for performing adaptive scheduling in an infrastructure environment that facilitate algorithm development, simulation, and/or continuous integration related to AV software. FIGS. 3-9 may be discussed in relation to each other and in relation to FIGS. 1-2.

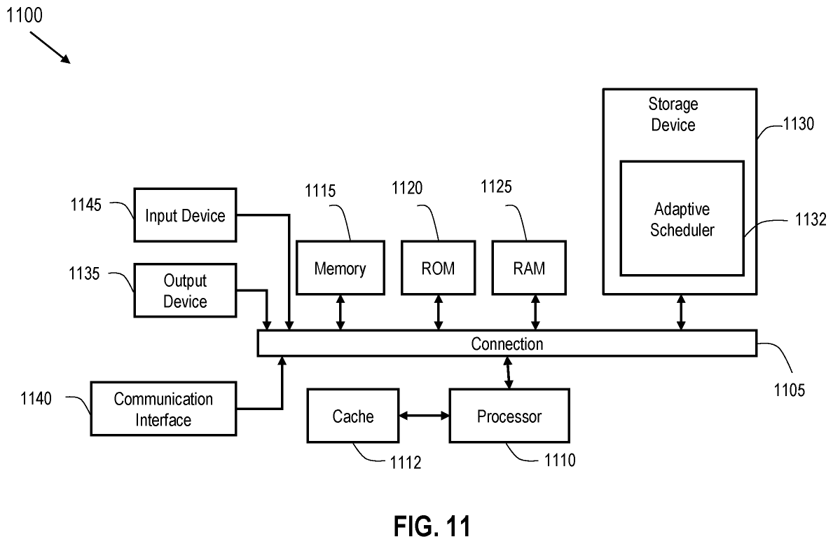

FIG. 3 illustrates an exemplary adaptive scheduling scheme 300 for scheduling AV software related tasks in an infrastructure environment, according to some embodiments of the present disclosure. In some aspects, the scheme 300 may be implemented by a computer-implemented system such as the data center 1050 of the FIG. 10 or the processor-based system 1100 of FIG. 11. In some aspects, the adaptive scheduling scheme 300 can be implemented by an infrastructure scheduler, for example, as part of the scheduling service layer 120 of FIG. 1.

As shown in FIG. 3, the scheme 300 may include an adaptive scheduler 310 including a scheduling manager 312 and a plurality of schedulers 314 (shown as 314a, 314b, and 314c) of different scheduler types. For instance, each of the plurality of schedulers 314 may utilize a different scheduling technique or strategy to schedule tasks for execution in an infrastructure environment (e.g., including the cloud platform 130 of FIG. 1 and/or the worker pool 240 of FIG. 2). In general, the adaptive scheduler 310 may include any suitable number of schedulers (e.g., 2, 3, 4, 5, or more), each implementing a different scheduling strategy. At a high level, the scheduling manager 312 may be a centralized scheduling manager that interfaces with clients (e.g., the clients 110) to receive job requests 302 requesting execution of tasks. In response, the scheduling manager 312 may adaptively select a most suitable scheduler 314 from the plurality of schedulers 314 to schedule each requested task based on one or more attributes of the respective task.

The scheduling or job requests 302 are shown as 302a, . . . , 302b. Each job request 302 may request execution of a job including one or more tasks associated with software for operating (or driving) a vehicle (e.g., the AV 1002 of FIG. 10). Some examples of operations or calculations for operating a vehicle may include, but are not limited to, a computation related to perception (e.g., for determining a perception of vehicle surroundings), a computation related to prediction (e.g., for predicting a future motion of the vehicle or a traffic participant), a computation related to planning (e.g., for planning a driving path for the AV), or a computation related to control (e.g., for controlling a maneuver of the vehicle).

In some aspects, each job request 302 may specify a task specification 304 for each requested task. In the example illustrated in FIG. 3, the job request 302a includes a list of task specifications 304a, . . . , 304b. Each task specification 304 may specify a variety of parameters associated with the respective task. In some aspects, the task specification 304a may indicate a task ID (e.g., A1) to identify a respective task from among the list of tasks requested by the job request 302a. Additionally or alternatively, the task specification 304a may indicate an amount of time (e.g., a runtime) for executing the task. Additionally or alternatively, the task specification 304a may indicate a file size, filename, and/or a file location of a file to be downloaded before and/or during the execution of the task. As an example, a certain file describing a driving scenario to be tested with a certain job or task (e.g., an AV simulation) may be downloaded as part of the task execution. Additionally or alternatively, the task specification 304a may indicate a file size, filename, and/or a file location of a file to be uploaded during and/or after the execution of the task. As an example, a certain file including outputs (e.g., AV driven paths and/or driving decisions) output by a certain task (e.g., an AV simulation) may be uploaded as part of the task execution. As another example, when a task is for an AV software build, there may be file(s) including driving scenario(s) or test case(s) to be downloaded and tested for the build and file(s) including respective test result(s) to be uploaded. Additionally or alternatively, the task specification 304a may specify a worker class to be used for executing the respective task. As an example, the worker class may specify that 2 CPU cores, 2 GPU core, and 128 GB of RAM may be used for executing the task. Additionally or alternatively, the task specification 304a may specify a priority of the task. As an example, the priority can be high, medium, or low. In other examples, the priority can be a particular priority level (e.g., a priority level of 4 out of 6 priority levels). Additionally or alternatively, the task specification 304a may specify a completion deadline, which may be a time at which the task has to be completed.

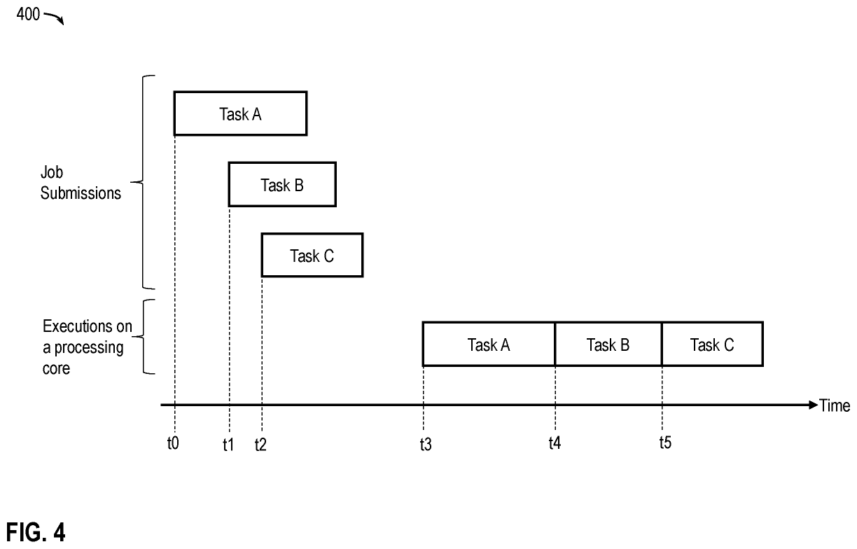

As discussed above, each scheduler 314 may perform scheduling using a different scheduling strategy or technique. As an example, the schedulers 314a may schedule tasks based on an order at which the respective requests are received, the scheduler 314b may schedule tasks based the completion deadline of respective tasks, and the scheduler 314c may schedule a task on multiple resources based on the multiple resources are available at the same time as will be discussed more fully below with reference to FIGS. 4-6.

FIGS. 4-6 illustrate various scheduling strategies for scheduling tasks in an infrastructure environment (e.g., the infrastructure platform 100 of FIG. 1). In FIGS. 4-6, the x-axes may represent time in some constant units.

FIG. 4 illustrates an exemplary FIFO-based scheduling scheme 400 used by the adaptive scheduler 310 for scheduling AV software related tasks in an infrastructure environment, according to some embodiments of the present disclosure. The scheme 400 may be implemented by a scheduler 314 of the adaptive scheduler 310. The scheme 400 may schedule tasks according to an order at which respective requests are received.

In the illustrated example of FIG. 4, at time t0, a first request for task A is submitted by a client (e.g., the clients 110) and received by the adaptive scheduler 310. At time t1, a second request for task B is submitted by a client and received by the adaptive scheduler 310. At time t2, a third request for task C is submitted by a client and received by the adaptive scheduler 310. The first, second, and third requests may be submitted by the same client or different clients. The first, second, and third requests may be from the same job submission or different job submissions. The tasks A, B, and C may be associated with AV software, for example, including one or more of an AV simulation (e.g., for a certain driving scenario), an AV software build (e.g., for development, integration, or release), and/or ML model training (e.g., for perception, prediction, planning, and/or control).

For simplicity, FIG. 4 illustrates the scheduling of tasks A, B, and C for execution on a single processing core (e.g., a CPU core 132, a GPU core 134, etc.). For example, the scheme 400 may schedule task A to begin execution at time t3, task B to begin execution at time t4 after task A, and task C to begin execution at time t5 after task B. In other examples, the scheme 400 can schedule tasks A, B, and C on different processing cores (e.g., where two or more of the tasks can be executed in parallel), which may be at a single worker or across different workers.

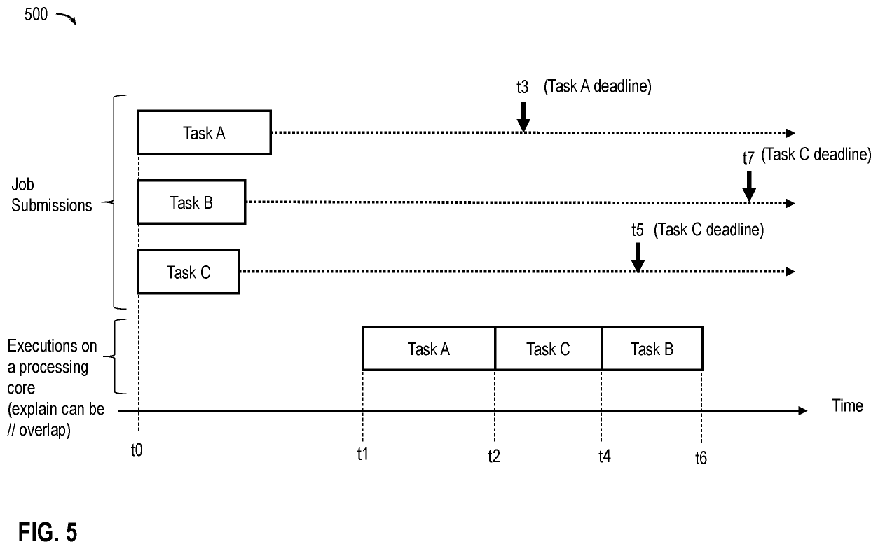

FIG. 5 illustrates an exemplary completion deadline-based scheduling scheme 500 by the adaptive scheduler 310 for scheduling AV software related tasks in an infrastructure environment, according to some embodiments of the present disclosure. The scheme 500 may be implemented by a scheduler 314 of the adaptive scheduler 310. The scheme 500 may prioritize a task with an earlier deadline over another task with a later deadline and guaranteeing that tasks are completed by the respective deadlines.

In the illustrated example of FIG. 5, at time t0, first, second, and third requests are submitted by one or more clients (e.g., the clients 110) and received by the adaptive scheduler 310. The first request may request execution of task A with a completion deadline at time t3. The second request may request execution of task B with a completion deadline at time t5. The third request may request execution of task C with a completion deadline at time t7. The first, second, and third requests may be submitted by the same client or different clients. The first, second, and third requests may be from the same job submission or different job submissions. Similar to the scheme 400, the tasks A, B, and C may be associated with AV software, for example, including one or more of an AV simulation (e.g., for a certain driving scenario), an AV software build (e.g., for development, integration, or release), and/or a ML model training (e.g., for perception, prediction, or planning). In some examples, the completion deadliners for tasks A, B, and C may each be specified by a respective task specification (e.g., the task specifications 304) as discussed above.

For simplicity, FIG. 5 illustrates the scheduling of tasks A, B, and C for execution on a single processing core (e.g., a CPU core 132, a GPU core 134, etc.). For example, the scheme 500 may schedule task A to begin execution at time t1 so that task A may be completed before its completion deadline (time t3). The scheme 500 may schedule task C before task B since task C has an earlier completion deadline than task B. As shown, the scheme 500 may schedule task C to begin execution at time t2 so that task C may be completed before its completion deadline (time t5) and may schedule task B to begin execution at time t2 so that task B may be completed before its completion deadline (time t7). In other examples, the scheme 500 can schedule tasks A, B, and C on different processing cores (e.g., where two or more of the tasks can be executed in parallel), which may be at a single worker or across different workers. Further, because the scheme 500 prioritizes tasks based on respective completion deadlines, in some instances, the scheme 500 may preempt a task that is in execution so that another task requested at a later time but with an earlier completion deadline may be executed.

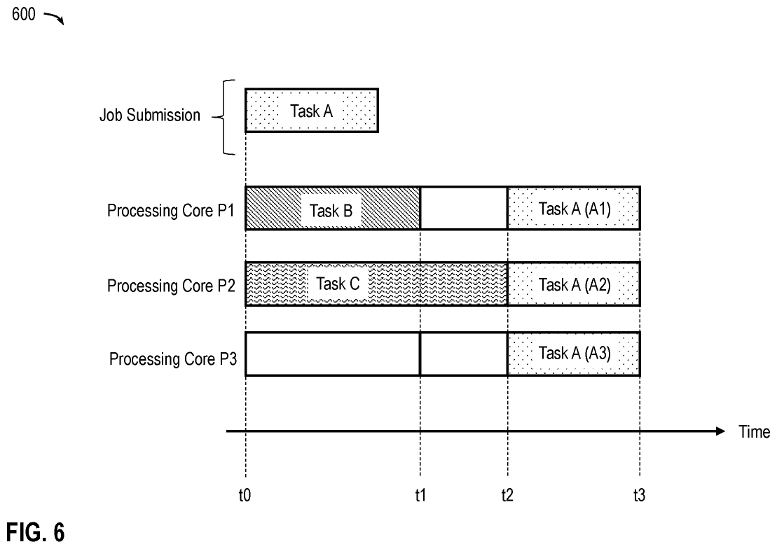

FIG. 6 illustrates an exemplary gang scheduling scheme 600 used by the adaptive scheduler 310 for scheduling AV software related tasks in an infrastructure environment, according to some embodiments of the present disclosure. The scheme 600 may be implemented by a scheduler 314 of the adaptive scheduler 310. The scheme 600 may schedule components (or sub-tasks) of an individual task, each on a different one of multiple resources based on the multiple resources are available at the same time.

In the illustrated example of FIG. 6, at time t0, a request for task A is submitted by a client (e.g., the clients 110) and received by the adaptive scheduler 310. Task A may include multiple sub-tasks or components represented by A1, A2, A3, which are to be executed concurrently (e.g., at about the same time) on separate processing resources (e.g., processing cores P1, P2, and P3), which may be at the same worker or across different workers. At the time of the job submission, processing core P1 may be executing task B, processing core P2 may be executing task C, and processing core P3 may be available (or idle with no task execution). At time t1, while task B on processing core P1 completed its execution and the processing core P3 remain available, the execution of task C on processing core P2 is still on going. As such, the scheme 600 may not schedule task A to begin execution. At time t2, task C on processing core P2 completed its execution and processing cores P1 and P3 remain available. As such, the scheme 600 may schedule task A to begin execution, where sub-tasks A1, A2, and A3 are scheduled to execute at concurrently on processing cores P1, P2, and P3, respectively.

In a certain aspect, the scheduler 314a may implement the FIFO-based scheduling scheme 400 of FIG. 4, the scheduler 314b may implement the completion deadline-based scheme 500 of FIG. 5, and the scheduler 314c may implement the gang scheduling scheme 600 of FIG. 6. In general, the adaptive scheduler 310 may include schedulers 314 implementing any suitable scheduling schemes.

Returning to FIG. 3, a certain scheduling strategy may be more suitable for scheduling a certain task, a certain task category, or a task with a certain task attribute and/or may better utilize resources. To that end, upon receiving a job request 302, the scheduling manager 312 may select, for each individual task (in the request 302), a most suitable scheduler from among the plurality of schedulers 314 to schedule the respective task. The selection may be based on certain attribute(s) of the individual task.

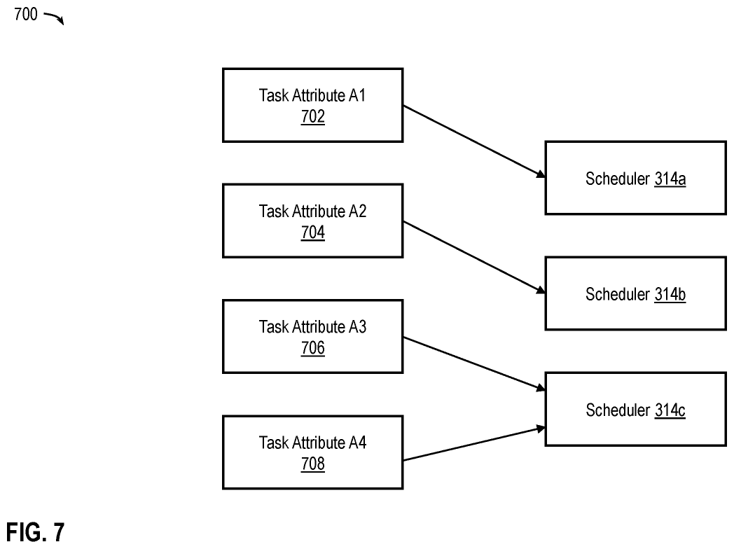

FIG. 7 illustrates an exemplary task-to-scheduler mapping scheme 700 for adaptive scheduling in an infrastructure environment, according to some embodiments of the present disclosure. The scheme 700 may be implemented by the adaptive scheduler 310 or more specifically the scheduling manager 312 of FIG. 3 to map a task to a scheduler (e.g., one of the schedulers 314). For simplicity, FIG. 7 illustrates a mapping between four task attributes 702, 704, 706, and 708 and three schedulers 314a, 314b, and 314c. However, in other examples, the scheme 700 can be scaled to map any suitable number of task attributes (e.g., 2, 3, 4, 5, 6, 7, 8 or more) or combinations of task attributes to any suitable number of schedulers (e.g., 3, 4, 5 or more).

As shown in FIG. 7, a task with a task attribute A1 702 map be mapped to the scheduler 314a, a task with a task attribute A2 704 map be mapped to the scheduler 314b, and a task with a task attribute A3 706 and a task attribute A4 708 map be mapped to the scheduler 314c. In general, one or more task attributes can be mapped to a scheduler 314, and in some instances, the mapping can be adapted or modified based on a certain condition (e.g., a time of the day/week/month, a workload of the schedulers 314, resource availabilities, feedback from historical statistics collected from task executed based on the adaptive scheduling, etc.). Further, in some instances, the mapping of a task to a particular scheduler can be based on a weighted score computed based on the task's attributes.

In some examples, the task attributes 702, 704, 706, and 708 may be related to task specific information (e.g., one or more of a task ID, a task runtime, a download file size/filename/file location, an upload file size/filename/file location, a worker class, a priority, and/or a competition deadline) as specified by the task specifications 304 discussed above. Additionally or alternatively, the task attributes 702, 704, 706, and 708 may be related to task types (or task categories). In some aspects, each task attribute 702, 704, 706, 708 may be associated with one of a simulation of an AV operation (e.g., a perception, a prediction, a path planning, a control, for example, for a certain traffic or driving scenario), an AV software build (e.g., for continuous integration), or ML model training (e.g., for perception, prediction, path planning, and/or control). For instance, the task attribute 702 may indicate an AV simulation, the task attribute 704 may indicate an AV software build, the task attribute 706 may indicate ML model training, and the task attribute 708 may indicate AV perception, AV prediction, AV planning, and/or AV control.

As an example, the scheduler 314a may implement the FIFO-based scheduling scheme 400 of FIG. 4, the scheduler 314b may implement the completion deadline-based scheduling scheme 500 of FIG. 5, and the scheduler 314c may implement the gang scheduling scheme 600 of FIG. 6. In an example, the scheduling manager 312 may map a task (having task attribute 702) related to an AV software build to the FIFO-based scheduler 314a, for example, based on AV software builds may generally have a shorter runtime compared to AV simulations and/or ML trainings. The scheduling manager 312 may map a task (having task attribute 704) related to an AV simulation to the completion deadline-based scheduler 314b, for example, based on AV simulations can take a long time for execution (e.g., blocking resources). The scheduling manager 312 may map a task (having task attributes 706 and 708) related to training of an ML model to the gang scheduler 314c, for example, based on ML model training may generally be computationally intensive and may benefit from parallel processing. In other examples, the scheduling manager 312 may utilize the FIFO-based scheduler 314a for scheduling AV simulations and utilize the completion deadline-based scheduler 314b for scheduling AV software builds. In yet other examples, the scheduling manager 312 may utilize the gang scheduler 314c for scheduling AV simulations and ML trainings.

In some examples, the scheduling manager 312 may determine whether a requested task has attribute(s) associated with an AV simulation, an AV software build, or training of an ML model (for AV perception, prediction, and/or path planning) based on information specified by the task specification (e.g., the task specification 304a) of the respective task. As an example, a file name and/or file location for upload or download in a task specification may indicate whether the task is associated with an AV simulation, an AV software build, or ML model training. In some examples, the scheduling manager 312 may determine whether a requested task is associated with an AV simulation, an AV software build, or ML model training based on a software configuration branch from which the software program for the task is originated. In some examples, the scheduling manager 312 may determine whether a requested task is associated with an AV simulation, an AV software build, or ML model training based on a task category indicated by a respective task specification. In some examples, if a task is assigned to a completion deadline-based scheduler 314, the completion deadline-based scheduler 314 schedule the based on a completion deadline specified by the respective task specification.

Returning to FIG. 3, after the scheduling manager 312 selected a scheduler 314 for a task, the selected scheduler 314 may determine a schedule for executing the respective task. Scheduling may include determining an order at which tasks are to be executed and assigning resources from a resource pool 320 on which the tasks are to be executed. The resource pool 320 may include compute resources (e.g., the CPU cores 132 and/or GPU cores 134), memory resources (e.g., the storage resources 136 and/or memory 138), and/or network resources (e.g., the network resources 140), for example, as discussed above with reference to FIG. 1. In some aspects, the resource pool 320 may include a plurality of workers (e.g., the VMs or workers 232) as discussed above with reference to FIG. 2.

In some aspects, the scheduling manager 312 may have a global view of usages and/or availability of resources in the resource pool 320. For instance, the global view may include an indication of which of the workers are available or occupied at any given time. In some instances, the resource pool 320 may be managed by a certain entity (e.g., a central resource report hub) that may provide a resource reporting service 330, for example, by sending a resource report 332 to the adaptive scheduler 310. The resource report 332 may include an indication of an availability and/or an occupancy of a certain resource (e.g., a computing resource, a memory resource, a network resource, and/or a worker or VM) in the resource pool 320. As such, the scheduling manager 312 may obtain resource availability information (the global resource view) from the received report 332. In some aspects, the scheduling manager 312 may provide the resource availability information to the schedulers 314, and each scheduler 314 may allocate or assign resource(s) for task execution according to the resource availability information.

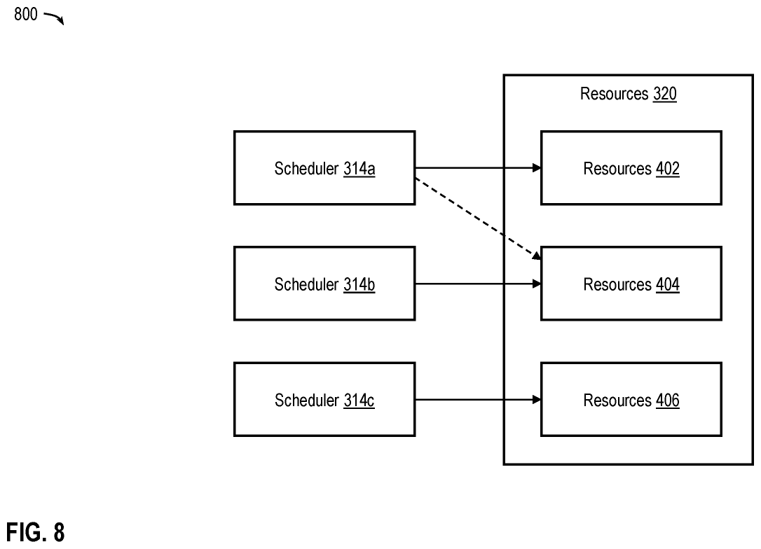

In some aspects, the resource pool 320 may be partitioned among the different schedulers 314. FIG. 8 illustrates an exemplary resource allocation scheme 800 for adaptive scheduling in an infrastructure environment, according to some embodiments of the present disclosure. As shown in FIG. 8, the resource pool 320 (e.g., including computing resources, memory resources, network resources, VMs, and/or workers) may be partitioned into a first subset of resources 402, a second subset of resources 404, and a third subset of resources 406. While FIG. 8 illustrates the first subset of resources 402, the second subset of resources 404, and the third subset of resources 406 as non-overlapping, in some examples, different subsets of resources can be partially overlapping. For instance, the subset of resources 402 and the subset of resources 404 may include at least one of a common compute resource, a common memory resource, a common network resource, or a common worker.

As further shown in FIG. 8, the scheduler 314a may schedule resource(s) from the first subset of resources 402 for task execution as shown by a solid arrow. The scheduler 314b may schedule resource(s) from the second subset of resources 404 for task execution as shown by a solid arrow. The scheduler 314c may schedule resource(s) from the third subset of resources 406 for task execution as shown by a solid arrow. In some instances, the mapping between schedulers 314 and the resources in the resource pool 320 can be flexible. For instance, the scheduler 314a can schedule a task for execution on a resource from the second subset of resources 404 as shown by the dashed arrow, for example, based on a lack of availability of resources in the first subset of resources 402. In some instances, multiple schedulers 314 may be mapped to the same subset of resources at any time. For instance, a FIFO-based scheduler (e.g., as discussed above with reference to FIG. 4) and a completion deadline-based scheduler (e.g., as discussed above with reference to FIG. 5) may allocate resources from the same subset of resources for task execution. For instance, a worker may execute one task scheduled by the FIFO-based scheduler and another task scheduled by the completion deadline-based scheduler at a different time or at the same time.

Returning to FIG. 3, after a selected scheduler 314 allocated a resource from the resource pool 320 for executing a task, the adaptive scheduler 310 may transmit an instruction 322 to initiate execution of the task on the allocated resource (e.g., according to the schedule determined by the selected scheduler 314). In some examples, the instruction 322 can be transmitted by the scheduling manager 312 (e.g., based on coordination between the scheduling manager 312 and the selected scheduler 314). In other examples, the instruction 322 can be transmitted by the selected scheduler 314. While FIG. 3 illustrates the instruction 322 being transmitted to the resource pool 320, the instruction 322 can be transmitted to an entity that manages the resource pool 320.

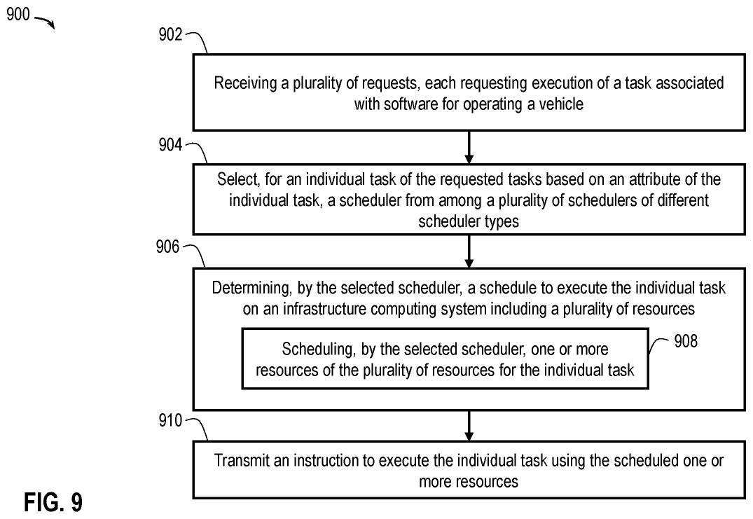

FIG. 9 is a flow diagram illustrating an exemplary adaptive scheduling process 900 for scheduling AV software related tasks in an infrastructure environment, according to some embodiments of the present disclosure. The process 900 can be implemented by a computer-implemented system (e.g., the data center of FIG. 1050 of FIG. 10 and/or the system 1100 of FIG. 11). In general, the process 900 may be performed using any suitable hardware components and/or software components. The process 900 may utilize similar mechanisms discussed above with reference to FIGS. 1-8. Operations are illustrated once each and in a particular order in FIG. 9, but the operations may be performed in parallel, reordered, and/or repeated as desired.

At 902, the computer-implemented system may receive a plurality of requests (e.g., the requests 302). Each request may request execution of a task associated with software for operating (or driving) a vehicle (e.g., the AV 1002 of FIG. 10). Some examples of operations or calculations for operating or driving a vehicle may include, but are not limited to, performing perception (e.g., to determine a perception of a vehicle's surroundings), prediction (e.g., to predict a future motion of the vehicle or a traffic participant), planning (e.g., to determine a driving path for the vehicle), and/or control (e.g., to control a maneuver of the vehicle). In some examples, each request may be a request to execute a job including one or more tasks.

At 904, the computer-implemented system may select, for an individual task of the requested tasks based on an attribute of the individual task, a scheduler from among a plurality of schedulers of different scheduler types. For instance, each scheduler of the plurality of schedulers may utilize a different scheduling technique or strategy to schedule tasks for execution. In some instances, the plurality of schedulers may correspond to the schedulers 314.

In some aspects, the attribute of the individual task may be associated with one of a simulation of a vehicle operation, a vehicle software build, or training of a machine learning model for at least one of a perception, a prediction, a planning, or a control associated with a driving decision. In some aspects, the selecting may include selecting a first scheduler of the plurality of schedulers based on a determination that the attribute of the individual task is associated with the simulation of the vehicle operation, where the first scheduler is configured to schedule tasks according to an order of respective requests are received, for example, as discussed above with reference to FIG. 4. In some aspects, the selecting may include selecting a second scheduler of the plurality of schedulers based on a determination that the attribute of the individual task is associated with the vehicle software build, where the second scheduler is configured to prioritize tasks according to respective completion deadlines, for example, as discussed above with reference to FIG. 5. In some aspects, the selecting may include selecting a third scheduler of the plurality of schedulers based on a determination that the attribute of the individual task is associated with the training of the machine learning model, where the scheduled first resource includes multiple compute resources, and the third scheduler is configured to schedule components of the individual task for concurrent execution based on the multiple compute resources are available at the same time, for example, as discussed above with reference to FIG. 6.

At 906, the computer-implemented system may determine, using the selected scheduler, a schedule to execute the individual task on an infrastructure computing system (e.g., the cloud platform 130) including a plurality of resources (e.g., in a resource pool similar to the worker pool 240 or the resource pool 320). The determining the schedule for the individual task may include scheduling one or more resources of the plurality of resources for the task. For instance, the schedule may specify that the one or more resources are allocated for executing the individual task beginning at a certain time, e.g., time t1. In some instances, the schedule may also specify an estimated duration (or runtime) for executing the individual task.

In some aspects, the plurality of resources may include a plurality of workers (e.g., the workers 232), each associated with one of a plurality of worker classes (e.g., the worker classes 230), and each worker class may include at least one of a compute resource (e.g., one or more CPU cores 132 and/or one or more GPU cores 134), a memory resource (e.g., the storage resources 136 and/or the memory resources 138), or a network resource (e.g., the network resources 140). In some aspects, each of the plurality of schedulers may be configured to utilize a different subset of the plurality of resources, for example, as discussed above with reference to FIG. 8. As an example, a first subset of the plurality of resources may be configured for the selected scheduler and a second, different subset of the plurality of resources may be configured for a different scheduler of the plurality of schedulers than the selected schedule. If the selected scheduler determines that there is no available resource in the first subset, the selected scheduler may select an available resource from the second subset for the task.

At 908, the computer-implemented system may transmit an instruction to execute the individual task using the scheduled first resource.

In some aspects, the scheduling of the resource for the individual task at 906 may be based on a resource availability report. In some aspects, the computer-implemented system may further receive the resource availability report including resource availability information.

Turning now to FIG. 10, this figure illustrates an example of an AV management system 1000. One of ordinary skill in the art will understand that, for the AV management system 1000 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 1000 includes an AV 1002, a data center 1050, and a client computing device 1070. The AV 1002, the data center 1050, and the client computing device 1070 may communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 1002 may navigate about roadways without a human driver based on sensor signals generated by multiple sensor systems 1004, 1006, and 1008. The sensor systems 1004-1008 may include different types of sensors and may be arranged about the AV 1002. For instance, the sensor systems 1004-1008 may comprise IMUs, cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 1004 may be a camera system, the sensor system 1006 may be a LIDAR system, and the sensor system 1008 may be a RADAR system. Other embodiments may include any other number and type of sensors.

AV 1002 may also include several mechanical systems that may be used to maneuver or operate AV 1002. For instance, the mechanical systems may include vehicle propulsion system 1030, braking system 1032, steering system 1034, safety system 1036, and cabin system 1038, among other systems. Vehicle propulsion system 1030 may include an electric motor, an internal combustion engine, or both. The braking system 1032 may include an engine brake, a wheel braking system (e.g., a disc braking system that utilizes brake pads), hydraulics, actuators, and/or any other suitable componentry configured to assist in decelerating AV 1002. The steering system 1034 may include suitable componentry configured to control the direction of movement of the AV 1002 during navigation. Safety system 1036 may include lights and signal indicators, a parking brake, airbags, and so forth. The cabin system 1038 may include cabin temperature control systems, in-cabin entertainment systems, and so forth. In some embodiments, the AV 1002 may not include human driver actuators (e.g., steering wheel, handbrake, foot brake pedal, foot accelerator pedal, turn signal lever, window wipers, etc.) for controlling the AV 1002. Instead, the cabin system 1038 may include one or more client interfaces (e.g., Graphical User Interfaces (GUIs), Voice User Interfaces (VUIs), etc.) for controlling certain aspects of the mechanical systems 1030-1038.

AV 1002 may additionally include a local computing device 1010 that is in communication with the sensor systems 1004-1008, the mechanical systems 1030-1038, the data center 1050, and the client computing device 1070, among other systems. The local computing device 1010 may include one or more processors and memory, including instructions that may be executed by the one or more processors. The instructions may make up one or more software stacks or components responsible for controlling the AV 1002; communicating with the data center 1050, the client computing device 1070, and other systems; receiving inputs from riders, passengers, and other entities within the AV's environment; logging metrics collected by the sensor systems 1004-1008; and so forth. In this example, the local computing device 1010 includes a perception stack 1012, a mapping and localization stack 1014, a planning stack 1016, a control stack 1018, a communications stack 1020, a High Definition (HD) geospatial database 1022, and an AV operational database 1024, among other stacks and systems.

Perception stack 1012 may enable the AV 1002 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 1004-1008, the mapping and localization stack 1014, the HD geospatial database 1022, other components of the AV, and other data sources (e.g., the data center 1050, the client computing device 1070, third-party data sources, etc.). The perception stack 1012 may detect and classify objects and determine their current and predicted locations, speeds, directions, and the like. In addition, the perception stack 1012 may determine the free space around the AV 1002 (e.g., to maintain a safe distance from other objects, change lanes, park the AV, etc.). The perception stack 1012 may also identify environmental uncertainties, such as where to look for moving objects, flag areas that may be obscured or blocked from view, and so forth.

Mapping and localization stack 1014 may determine the AV's position and orientation (pose) using different methods from multiple systems (e.g., GPS, IMUs, cameras, LIDAR, RADAR, ultrasonic sensors, the HD geospatial database 1022, etc.). For example, in some embodiments, the AV 1002 may compare sensor data captured in real-time by the sensor systems 1004-1008 to data in the HD geospatial database 1022 to determine its precise (e.g., accurate to the order of a few centimeters or less) position and orientation. The AV 1002 may focus its search based on sensor data from one or more first sensor systems (e.g., GPS) by matching sensor data from one or more second sensor systems (e.g., LIDAR). If the mapping and localization information from one system is unavailable, the AV 1002 may use mapping and localization information from a redundant system and/or from remote data sources.

The planning stack 1016 may determine how to maneuver or operate the AV 1002 safely and efficiently in its environment. For example, the planning stack 1016 may receive the location, speed, and direction of the AV 1002, geospatial data, data regarding objects sharing the road with the AV 1002 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 1002 from one point to another. The planning stack 1016 may determine multiple sets of one or more mechanical operations that the AV 1002 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 1016 may select from multiple backup plans to carry out. For example, while preparing to change lanes to turn right at an intersection, another vehicle may aggressively cut into the destination lane, making the lane change unsafe. The planning stack 1016 could have already determined an alternative plan for such an event, and upon its occurrence, help to direct the AV 1002 to go around the block instead of blocking a current lane while waiting for an opening to change lanes.

The control stack 1018 may manage the operation of the vehicle propulsion system 1030, the braking system 1032, the steering system 1034, the safety system 1036, and the cabin system 1038. The control stack 1018 may receive sensor signals from the sensor systems 1004-1008 as well as communicate with other stacks or components of the local computing device 1010 or a remote system (e.g., the data center 1050) to effectuate operation of the AV 1002. For example, the control stack 1018 may implement the final path or actions from the multiple paths or actions provided by the planning stack 1016. Implementation may involve turning the routes and decisions from the planning stack 1016 into commands for the actuators that control the AV's steering, throttle, brake, and drive unit.

In some aspects, the perception stack 1012, the localization stack 1014, the planning stack 1016, and the control stack 1018 may be part of an AV compute software as discussed herein.

The communication stack 1020 may transmit and receive signals between the various stacks and other components of the AV 1002 and between the AV 1002, the data center 1050, the client computing device 1070, and other remote systems. The communication stack 1020 may enable the local computing device 1010 to exchange information remotely over a network, such as through an antenna array or interface that may provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (L10), Citizens Broadband Radio Service (CBRS), MULTEFIRE, etc.). The communication stack 1020 may also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 1022 may store HD maps and related data of the streets upon which the AV 1002 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer may include geospatial information of traffic signal lights, traffic signs, and other road objects and related attributes.

The AV operational database 1024 may store raw AV data generated by the sensor systems 1004-1008 and other components of the AV 1002 and/or data received by the AV 1002 from remote systems (e.g., the data center 1050, the client computing device 1070, etc.). In some embodiments, the raw AV data may include HD LIDAR point cloud data, image or video data, RADAR data, GPS data, and other sensor data that the data center 1050 may use for creating or updating AV geospatial data.

The data center 1050 may be a private cloud (e.g., an enterprise network, a co-location provider network, etc.), a public cloud (e.g., an Infrastructure as a Service (IaaS) network, a PaaS network, a SaaS network, or other Cloud Service Provider (CSP) network), a hybrid cloud, a multi-cloud, and so forth. The data center 1050 may include one or more computing devices remote to the local computing device 1010 for managing a fleet of AVs and AV-related services. For example, in addition to managing the AV 1002, the data center 1050 may also support a ridesharing service, a delivery service, a remote/roadside assistance service, street services (e.g., street mapping, street patrol, street cleaning, street metering, parking reservation, etc.), and the like.

The data center 1050 may send and receive various signals to and from the AV 1002 and the client computing device 1070. These signals may include sensor data captured by the sensor systems 1004-1008, roadside assistance requests, software updates, ridesharing pick-up and drop-off instructions, and so forth. In this example, the data center 1050 includes one or more of a data management platform 1052, an Artificial Intelligence/Machine Learning (AI/ML) platform 1054, a simulation platform 1056, an adaptive scheduling platform 1057, a remote assistance platform 1058, a ridesharing platform 1060, and a map management platform 1062, among other systems.

Data management platform 1052 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 1050 may access data stored by the data management platform 1052 to provide their respective services.

The AI/ML platform 1054 may provide the infrastructure for training and evaluating machine learning algorithms for operating the AV 1002, the simulation platform 1056, the remote assistance platform 1058, the ridesharing platform 1060, the map management platform 1062, and other platforms and systems. Using the AI/ML platform 1054, data scientists may prepare data sets from the data management platform 1052; select, design, and train machine learning models; evaluate, refine, and deploy the models; maintain, monitor, and retrain the models; and so on.

The simulation platform 1056 may enable testing and validation of the algorithms, machine learning models, neural networks, and other development efforts for the AV 1002, the remote assistance platform 1058, the ridesharing platform 1060, the map management platform 1062, and other platforms and systems. The simulation platform 1056 may replicate a variety of driving environments and/or reproduce real-world scenarios from data captured by the AV 1002, including rendering geospatial information and road infrastructure (e.g., streets, lanes, crosswalks, traffic lights, stop signs, etc.) obtained from the map management platform 1062; modeling the behavior of other vehicles, bicycles, pedestrians, and other dynamic elements; simulating inclement weather conditions, different traffic scenarios; and so on.

The adaptive scheduling platform 1057 may perform adaptive scheduling to schedule AV software related jobs and/or tasks (e.g., including AV simulations, AV software code builds, ML model training, etc.) as discussed herein.

The remote assistance platform 1058 may generate and transmit instructions regarding the operation of the AV 1002. For example, in response to an output of the AI/ML platform 1054 or other system of the data center 1050, the remote assistance platform 1058 may prepare instructions for one or more stacks or other components of the AV 1002.

The ridesharing platform 1060 may interact with a customer of a ridesharing service via a ridesharing application 1072 executing on the client computing device 1070. The client computing device 1070 may be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 1072. The client computing device 1070 may be a customer's mobile computing device or a computing device integrated with the AV 1002 (e.g., the local computing device 1010). The ridesharing platform 1060 may receive requests to be picked up or dropped off from the ridesharing application 1072 and dispatch the AV 1002 for the trip.

Map management platform 1062 may provide a set of tools for the manipulation and management of geographic and spatial (geospatial) and related attribute data. The data management platform 1052 may receive LIDAR point cloud data, image data (e.g., still image, video, etc.), RADAR data, GPS data, and other sensor data (e.g., raw data) from one or more AVs 1002, Unmanned Aerial Vehicles (UAVs), satellites, third-party mapping services, and other sources of geospatially referenced data. The raw data may be processed, and map management platform 1062 may render base representations (e.g., tiles (2D), bounding volumes (3D), etc.) of the AV geospatial data to enable users to view, query, label, edit, and otherwise interact with the data. Map management platform 1062 may manage workflows and tasks for operating on the AV geospatial data. Map management platform 1062 may control access to the AV geospatial data, including granting or limiting access to the AV geospatial data based on user-based, role-based, group-based, task-based, and other attribute-based access control mechanisms. Map management platform 1062 may provide version control for the AV geospatial data, such as to track specific changes that (human or machine) map editors have made to the data and to revert changes when necessary. Map management platform 1062 may administer release management of the AV geospatial data, including distributing suitable iterations of the data to different users, computing devices, AVs, and other consumers of HD maps. Map management platform 1062 may provide analytics regarding the AV geospatial data and related data, such as to generate insights relating to the throughput and quality of mapping tasks.

In some embodiments, the map viewing services of map management platform 1062 may be modularized and deployed as part of one or more of the platforms and systems of the data center 1050. For example, the AI/ML platform 1054 may incorporate the map viewing services for visualizing the effectiveness of various object detection or object classification models, the simulation platform 1056 may incorporate the map viewing services for recreating and visualizing certain driving scenarios, the remote assistance platform 1058 may incorporate the map viewing services for replaying traffic incidents to facilitate and coordinate aid, the ridesharing platform 1060 may incorporate the map viewing services into the client application 1072 to enable passengers to view the AV 1002 in transit en route to a pick-up or drop-off location, and so on.

FIG. 11 illustrates an example processor-based system with which some aspects of the subject technology may be implemented. For example, processor-based system 1100 may be any computing device making up, or any component thereof in which the components of the system are in communication with each other using connection 1105. Connection 1105 may be a physical connection via a bus, or a direct connection into processor 1110, such as in a chipset architecture. Connection 1105 may also be a virtual connection, networked connection, or logical connection.

In some embodiments, computing system 1100 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1100 includes at least one processing unit (CPU or processor) 1110 and connection 1105 that couples various system components including system memory 1115, such as Read-Only Memory (ROM) 1120 and RAM 1125 to processor 1110. Computing system 1100 may include a cache of high-speed memory 1112 connected directly with, in close proximity to, or integrated as part of processor 1110.

Processor 1110 may include any general-purpose processor and a hardware service or software service, such as an adaptive scheduler software 1132 stored in storage device 1130, configured to control processor 1110 as well as a special-purpose processor where software instructions are incorporated into the actual processor design. The adaptive scheduling software 1132 may perform adaptive scheduling for AV software related jobs and/or tasks as discussed herein. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which may represent any number of input mechanisms, such as a microphone for speech, a touch-sensitive screen for gesture or graphical input, keyboard, mouse, motion input, speech, etc. Computing system 1100 may also include output device 1135, which may be one or more of a number of output mechanisms known to those of skill in the art. In some instances, multimodal systems may enable a user to provide multiple types of input/output to communicate with computing system 1100. Computing system 1100 may include communications interface 1140, which may generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEQCON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 may be a non-volatile and/or non-transitory and/or computer-readable memory device and may be a hard disk or other types of computer-readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, RAM, Atatic RAM (SRAM), Dynamic RAM (DRAM), ROM, Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 1130 may include software services, servers, services, etc., that when the code that defines such software is executed by the processor 1110, it causes the system 1100 to perform a function. In some embodiments, a hardware service that performs a particular function may include the software component stored in a computer-readable medium in connection with the necessary hardware components, such as processor 1110, connection 1105, output device 1135, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Example 1 includes a computer-implemented system, including one or more processing units; and one or more non-transitory computer-readable media storing instructions, when executed by the one or more processing units, cause the one or more processing units to perform operations including receiving a plurality of requests, each requesting execution of a task associated with software for operating (or diving) a vehicle; selecting, for an individual task of the requested tasks based on an attribute of the individual task, a scheduler from among a plurality of schedulers of different scheduler types; determining, by the selected scheduler, a schedule to execute the individual task on an infrastructure computing system including a plurality of resources, where the determining includes scheduling one or more resources of the plurality of resources; and transmitting an instruction to execute the individual task using the scheduled one or more resources.

In Example 2, the computer-implemented system of example 1 can optionally include where the attribute of the individual task is associated with one of a simulation of a vehicle operation, a vehicle software build, or training of a machine learning model for at least one of a perception, a prediction, a planning, or a control associated with a driving decision.

In Example 3, the computer-implemented system of any one of examples 1-2 can optionally include where the selecting includes determining that the attribute of the individual task is associated with the simulation of the vehicle operation; and selecting a first scheduler from the plurality of schedulers in response to determining that the attribute of the individual task is associated with the simulation of the vehicle operation, the first scheduler scheduling tasks according to an order of respective requests are received.

In Example 4, the computer-implemented system of any one of examples 1-2 can optionally include where the selecting includes determining that the attribute of the individual task is associated with the vehicle software code build; and selecting a first scheduler from the plurality of schedulers in response to determining that the attribute of the individual task is associated with the vehicle software code build, the first scheduler prioritizing tasks according to respective completion deadlines.

In Example 5, the computer-implemented system of any one of examples 1-2 can optionally include where the selecting includes determining that the attribute of the individual task is associated with the training of the machine learning model; and selecting a first scheduler from the plurality of schedulers in response to determining that the attribute of the individual task is associated with the training of the machine learning model, the first scheduler scheduling related task components for concurrent execution.

In Example 6, the computer-implemented system of any one of examples 1-5 can optionally include where the plurality of resources includes a plurality of workers, each including at least one of a compute resource, a memory resource, or a network resource; and the scheduling the one or more resources for the individual task comprises assigning one or more workers of the plurality of workers to execute the individual task.

In Example 7, the computer-implemented system of any one of examples 1-6 can optionally include where each of the plurality of schedulers is configured to utilize a different subset of the plurality of resources.

In Example 8, the computer-implemented system of example 7 can optionally include where a first subset of the plurality of resources is configured for the selected scheduler, a second subset of the plurality of resources is configured for a different scheduler of the plurality of schedulers than the selected scheduler, and the scheduling the one or more resources for the individual task includes scheduling the one or more resources from the second subset of the plurality of resources based on a determination that there is a lack of an available resource in the first subset of the plurality of resources.

In Example 9, the computer-implemented system of any one of examples 1-8 can optionally include where the scheduling the one or more resources for the individual task is based on a resource availability report.

In Example 10, the computer-implemented system of any one of examples 1-9 can optionally include where the operations further include receiving the resource availability report including an indication of an availability of the one or more resources.

Example 11 includes a computer-implemented method, the method including receiving, by an adaptive scheduler, a request to execute a job including one or more tasks associated with software for operating (or driving) a vehicle, where the adaptive scheduler includes a plurality of schedulers, each of which is based on a different scheduling technique; selecting a scheduler from among a plurality of schedulers for an individual task of the one or more tasks, where each of the plurality of schedulers is based on a different scheduling technique; determining, by the selected scheduler based on an attribute of the individual task, a schedule for executing the individual task, where the determining includes scheduling one or more resources of a plurality of resources for the individual task; and transmitting an instruction to execute the individual task using the scheduled one or more resources.

In Example 12, the computer-implemented method of example claim 11 can optionally include determining whether the attribute of the individual task is associated with a simulation of a vehicle operation, a vehicle software build, or training of a machine learning model for at least one of a perception, a prediction, a planning, or a control associated with a driving decision.

In Example 13, the computer-implemented method of any one of examples 11-12 can optionally include where the selecting includes selecting a first-in-first-out (FIFO)-based scheduler from the plurality of schedulers in response to determining that the attribute of the individual task is associated with the simulation of the vehicle operation.

In Example 14, the computer-implemented method of any one of examples 11-12 can optionally include where the selecting includes selecting a completion deadline-based scheduler from the plurality of schedulers in response to determining that the attribute of the individual task is associated with the vehicle software build.

In Example 15, the computer-implemented method of any one of examples 11-12 can optionally include where the selecting includes selecting a gang scheduler from the plurality of schedulers in response to determining that the attribute of the individual task is associated with the training of the machine learning model.

In Example 16, the computer-implemented method of any one of examples 11-15 can optionally include where the plurality of resources includes a plurality of workers, each including at least one of a compute resource, a memory resource, or a network resource; and the scheduling the one or more resources for the individual task comprises assigning one or more virtual machines of the plurality of virtual machines to execute the individual task.

In Example 17, the computer-implemented method of any one of examples 11-16 can optionally include where the scheduling the one or more resources for the individual task is based on a resource availability report.

Example 18 includes one or more non-transitory, computer-readable media encoded with instructions that, when executed by one or more processing units, cause the one or more processing units to perform operations including receiving a plurality of requests, each requesting execution of a job including one or more tasks associated with a software for operating (or driving) a vehicle operation; mapping each individual task to one of a plurality of schedulers of different scheduling types based on an attribute of the respective individual task; determining, for each individual task by a respective mapped scheduler, a schedule to execute the respective individual task, where the determining includes scheduling a resource from a plurality of resources for each individual task; and transmitting, for each individual task, an instruction to execute the respective individual task using a respective scheduled resource.

In Example 19, the one or more non-transitory, computer-readable media of example 18 can optionally include where the mapping includes mapping a first individual task of the requested tasks to a first-in-first-out (FIFO)-based scheduler of the plurality of schedulers based on the first individual task is associated with the simulation of the vehicle operation; mapping a second individual task of the requested tasks to a completion deadline-based scheduler of the plurality of schedulers based on the second individual task is associated with the vehicle software build; and mapping a third individual task of the requested tasks to a gang scheduler of the plurality of schedulers based on the third individual task is associated with the training of the machine learning model.

In Example 20, the one or more non-transitory, computer-readable media of any one of examples 18-19 can optionally include where each of the FIFO-based scheduler, the completion deadline-based scheduler, and the gang scheduler is configured to schedule resources from a different subset of the plurality of resources.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

1. A computer-implemented system, comprising:
one or more processing units; and
one or more non-transitory computer-readable media storing instructions, when executed by the one or more processing units, cause the one or more processing units to perform operations comprising:
receiving a plurality of requests, each requesting execution of a task associated with software for operating a vehicle;
selecting, for an individual task of the requested tasks based on an attribute of the individual task, a scheduler from among a plurality of schedulers of different scheduler types;
determining, by the selected scheduler, a schedule to execute the individual task on an infrastructure computing system including a plurality of resources, wherein the determining comprises scheduling one or more resources of the plurality of resources for the individual task; and
transmitting an instruction to execute the individual task using the scheduled one or more resources.

2. The computer-implemented system of claim 1, wherein the attribute of the individual task is associated with one of:
a simulation of a vehicle operation,
a vehicle software build, or
training of a machine learning model for at least one of a perception, a prediction, a planning, or a control associated with a driving decision.

3. The computer-implemented system of claim 2, wherein the selecting comprises:
determining that the attribute of the individual task is associated with the simulation of the vehicle operation; and
selecting a first scheduler from the plurality of schedulers in response to determining that the attribute of the individual task is associated with the simulation of the vehicle operation, wherein the first scheduler schedules tasks according to an order of respective requests are received.

4. The computer-implemented system of claim 2, wherein the selecting comprises:
determining that the attribute of the individual task is associated with the vehicle software code build; and
selecting a first scheduler from the plurality of schedulers in response to determining that the attribute of the individual task is associated with the vehicle software code build, wherein the first scheduler prioritizes tasks according to respective completion deadlines.

5. The computer-implemented system of claim 2, wherein the selecting comprises:
determining that the attribute of the individual task is associated with the training of the machine learning model; and
selecting a first scheduler from the plurality of schedulers in response to determining that the attribute of the individual task is associated with the training of the machine learning model, wherein the first scheduler schedules related task components for concurrent execution.

6. The computer-implemented system of claim 1, wherein:
the plurality of resources comprises a plurality of workers, each including at least one of a compute resource, a memory resource, or a network resource, and
the scheduling the one or more resources for the individual task comprises assigning one or more workers of the plurality of workers to execute the individual task.

7. The computer-implemented system of claim 1, wherein each of the plurality of schedulers is configured to utilize a different subset of the plurality of resources.

8. The computer-implemented system of claim 7, wherein:
a first subset of the plurality of resources is configured for the selected scheduler;
a second subset of the plurality of resources is configured for a different scheduler of the plurality of schedulers than the selected scheduler; and
the scheduling the one or more resources for the individual task comprises scheduling the one or more resources from the second subset of the plurality of resources based on a determination that there is a lack of an available resource in the first subset of the plurality of resources.

9. The computer-implemented system of claim 1, wherein the scheduling the one or more resources for the individual task is based on a resource availability report.

10. The computer-implemented system of claim 9, wherein the operations further comprise:
receiving the resource availability report including an indication of an availability of the one or more resources.

11. A computer-implemented method, the method comprising:
receiving, by an adaptive scheduler, a request to execute a job including one or more tasks associated with software for operating a vehicle, wherein the adaptive scheduler includes a plurality of schedulers, each of which is based on a different scheduling technique;
selecting a scheduler from among the plurality of schedulers for an individual task of the one or more tasks;
determining, by the selected scheduler based on an attribute of the individual task, a schedule for executing the individual task, wherein the determining comprises scheduling one or more resources of a plurality of resources for the individual task; and
transmitting an instruction to execute the individual task using the scheduled one or more resources.

12. The computer-implemented method of claim 11, further comprising:
determining whether the attribute of the individual task is associated with:
a simulation of a vehicle operation,
a vehicle software build, or
training of a machine learning model for at least one of a perception, a prediction, a planning, or a control associated with a driving decision.

13. The computer-implemented method of claim 12, wherein the selecting comprises:
selecting a first-in-first-out (FIFO)-based scheduler from the plurality of schedulers in response to determining that the attribute of the individual task is associated with the simulation of the vehicle operation.

14. The computer-implemented method of claim 12, wherein the selecting comprises:
selecting a completion deadline-based scheduler from the plurality of schedulers in response to determining that the attribute of the individual task is associated with the vehicle software build.

15. The computer-implemented method of claim 12, wherein the selecting comprises:
selecting a gang scheduler from the plurality of schedulers in response to determining that the attribute of the individual task is associated with the training of the machine learning model.

16. The computer-implemented method of claim 11, wherein:
the plurality of resources comprises a plurality of virtual machines, each including at least one of a compute resource, a memory resource, or a network resource; and
the scheduling the one or more resources for the individual task comprises assigning one or more virtual machines of the plurality of virtual machines to execute the individual task.

17. The computer-implemented method of claim 11, wherein the scheduling the one or more resources for the individual task is based on a resource availability report.

18. One or more non-transitory, computer-readable media encoded with instructions that, when executed by one or more processing units, cause the one or more processing units to perform operations comprising:
receiving a plurality of requests, each requesting execution of a job including one or more tasks associated with software for operating a vehicle;
mapping each individual task of the requested tasks to one of a plurality of schedulers, each of which is based on a different scheduling technique;
determining, for each individual task by a respective mapped scheduler, a schedule to execute the respective individual task, wherein the determining comprises scheduling a resource from a plurality of resources for each individual task; and
transmitting, for each individual task, an instruction to execute the respective individual task using the respective scheduled resource.

19. The one or more non-transitory, computer-readable media of claim 18, wherein the mapping comprises:
mapping a first individual task of the requested tasks to a first-in-first-out (FIFO)-based scheduler of the plurality of schedulers based on the first individual task is associated with a simulation of a vehicle operation;
mapping a second individual task of the requested tasks to a completion deadline-based scheduler of the plurality of schedulers based on the second individual task is associated with a vehicle software build; and
mapping a third individual task of the requested tasks to a gang scheduler of the plurality of schedulers based on the third individual task is associated with training of a machine learning model for at least one of a perception, a prediction, a planning, or a control associated with a driving decision.

20. The one or more non-transitory, computer-readable media of claim 19, wherein each of the FIFO-based scheduler, the completion deadline-based scheduler, and the gang scheduler is configured to schedule resources from a different subset of the plurality of resources.
